(19) United States
(12) Patent Application Publication
(10) Pub. No.: US 2025/0264667 A1
(43) Pub. Date: Aug. 21, 2025

(54) CORE PITCH CONTROL IN FIBER ARRAYS

(71) Applicant: CORNING RESEARCH & DEVELOPMENT CORPORATION, CORNING, NY (US)

(72) Inventors: Chia-Hang Chang, Taoyuan City (TW); Ximao Feng, San Mateo, CA (US); Chunlei He, Dongguan City (CN); Wen-Lung Kuang, Taoyuan City (TW); Shudong Xiao, Fremont, CA (US); Andy Fenglei Zhou, Fremont, CA (US)

(21) Appl. No.: 19/202,488

(22) Filed: May 8, 2025

Related U.S. Application Data
(63) Continuation of application No. PCT/US2023/036836, filed on Nov. 6, 2023.
(60) Provisional application No. 63/423,524, filed on Nov. 8, 2022.

(51) Int. Cl. G02B 6/36

(52) U.S. Cl. CPC G02B 6/368

(57) ABSTRACT

A system is provided having a fiber array structure with a first and second portion. The first portion has a first surface with a first set of grooves. The second portion has a second surface with a second set of grooves, including end grooves and additional groove(s) between the end grooves. A first array of fibers is positioned within the first set of grooves. A second array of fibers is positioned within the second set of grooves. The first portion is placed adjacent to the second portion so that the first surface faces the second surface and so that grooves extend parallel to each other. A first spacer is provided between the arrays of fibers. A first dummy fiber is provided in an end groove and assists in maintaining a rotational orientation and/or a position of the first spacer with respect to the first array of fibers.

### PRIORITY APPLICATION

This application is a continuation of International Patent Application Serial Number PCT/US2023/036836 filed on Nov. 6, 2023, which claims priority to U.S. Application No. 63/423,524, filed Nov. 8, 2022, the entirety of which is incorporated herein by reference.

### FIELD

Embodiments of the present disclosure relate generally to the use of a contact feature, such as a dummy fiber, to assist in controlling the rotational orientation and/or the position of fibers within a fiber array structure.

### BACKGROUND

Two-dimensional fiber arrays have been used to create high fiber density optical interconnects for high density applications in optical communication. These fiber arrays are beneficial as they permit high fiber densities, allowing the overall footprint of electrical components to be reduced. However, maintaining the appropriate position and orientation of fibers is often challenging as the fiber density increases. A failure to maintain an appropriate fiber position causes the fibers to be less effective, and a failure to maintain an appropriate orientation for fibers often causes fibers such as polarization maintaining fibers and multi-core fibers to be less effective.

### SUMMARY

Contact features such as dummy fibers are provided in various embodiments to assist in controlling the rotational orientation and/or the position of the fibers in a fiber array structure. Fiber array structures may be provided so that one or more spacers are provided between a first array of fibers and a second array of fibers, with the spacers being in contact with the first array of fibers and the second array of fibers. Contact features contact the spacer to assist in controlling the rotational orientation and/or the position of the spacer. By doing so, the spacer is maintained in an appropriate orientation and/or position, and this prevents fibers in fiber arrays from moving away from their appropriate orientation and/or position. By maintaining fibers in their correct orientation and/or position, one may better ensure that the fibers work properly and are not defective.

A first array of fibers is provided in a first set of grooves, and a second array of fibers is provided in a second set of grooves. Where dummy fibers are used, additional end grooves may be provided on each end of a set of grooves, and each dummy fiber may be at least partially received within one of the additional end grooves. The dummy fibers extend out of the additional end grooves until the dummy fibers contact a spacer, and this contact assists in preventing unwanted deviation from the appropriate orientation and/or position of the spacer. Notably, the positioning and orientation of the spacer impacts the relative position and orientation of various components such as the other fibers and other portions of the fiber array structure, so maintaining the spacer in the appropriate orientation and position is important.

It is particularly important to maintain fibers in the appropriate orientation where polarization maintaining fibers or multi-core fibers are used. Furthermore, while dummy fibers are one example of a contact feature, the contact feature may be some other object that is attachable to a fiber array structure, or the contact feature may be integral to a portion of the fiber array structure.

In an example embodiment, a system for improved positioning of fibers is provided. The system includes a fiber array structure with a first portion and a second portion. The first portion has a first surface with a first set of grooves defined in the first surface. The second portion has a second surface with a second set of grooves defined in the second surface, and the second set of grooves includes a first end groove, a second end groove, and one or more additional grooves between the first end groove and the second end groove. The system also includes a first array of fibers, and each fiber of the first array of fibers is positioned within a groove of the first set of grooves. Furthermore, the system includes a second array of fibers, and each fiber of the second array of fibers is positioned within a groove of the second set of grooves. The system also includes a first spacer and a first dummy fiber. The first portion of the fiber array structure is configured to be placed adjacent to the second portion of the fiber array structure so that the first surface of the first portion faces the second surface of the second portion and so that the first set of grooves extend parallel to the second set of grooves. The first spacer is provided between the first array of fibers and the second array of fibers. Also, the first dummy fiber is provided in one of the first end groove or the second end groove, and the first dummy fiber is configured to assist in maintaining a rotational orientation and/or a position of the first spacer with respect to at least the first array of fibers.

In some embodiments, the first dummy fiber may be configured to contact the first spacer when the system is assembled. Additionally, in some embodiments, the first spacer may be configured to contact each of the fibers in the first array of fibers and the second array of fibers when the first array of fibers is received in the first set of grooves and when the second array of fibers is received in the second set of grooves. Furthermore, in some embodiments, the first dummy fiber may be configured to assist in maintaining a rotational orientation and/or a position of at least one fiber in the first array of fibers or the second array of fibers.

In some embodiments, the first dummy fiber may be configured to contact the first spacer to assist in maintaining the rotational orientation and/or the position of the first spacer. Contact between the first dummy fiber and the first spacer may cause the first spacer to contact a fiber in the first array of fibers or the second array of fibers so that the fiber may be maintained in a proper rotational orientation and/or a proper position within a groove of the first set of grooves or the second set of grooves. Additionally, in some embodiments, the first dummy fiber may be configured to assist in controlling the orientation of a fiber in the first array of fibers or the second array of fibers. Furthermore, in some embodiments, a fiber within the first array of fibers or the second array of fibers may be a polarization maintaining optical fiber or a multi-core fiber. Furthermore, in some embodiments, the system may also include a second dummy fiber. Where this is the case, the first dummy fiber may be provided in the first end groove, and the second dummy fiber may be provided in the second end groove. In some embodiments, a fiber of the first array of fibers or the second array of fibers may be an optical fiber.

In some embodiments, the first array of fibers and the second array of fibers may extend in a first direction, the first spacer may extend in a second direction, and the second direction may be perpendicular to the first direction. In some embodiments, each groove within the first set of grooves and the second set of grooves may extend in a lengthwise direction. The first set of grooves may be aligned in a transverse direction that is perpendicular to the lengthwise direction, and the second set of grooves may be aligned in the transverse direction. Further, the first portion and the second portion may be positioned relative to each other so that the first set of grooves and the second set of grooves are offset from each other in the transverse direction.

In some embodiments, the system may also include one or more additional spacers. The first spacer and the additional spacer(s) may be provided between the first array of fibers and the second array of fibers, and the first dummy fiber may be configured to assist in controlling the rotational orientation and/or the position of the first spacer and the additional spacer(s).

In some embodiments, the second portion may have an opposing surface opposite of the second surface. Further, the fiber array structure may also include a third portion, a third array of fibers, and a second spacer. The third portion may have a third surface with a third set of grooves defined in the third surface, and each fiber of the third array of fibers may be positioned within a groove of the third set of grooves. The second portion of the fiber array structure may be configured to be positioned between the first portion and the third portion of the fiber array structure, and the second portion of the fiber array structure may be configured to be placed adjacent to the third portion of the fiber array structure so that the opposing surface of the second portion faces the third surface of the third portion and so that the second set of grooves extend parallel to the third set of grooves. The second spacer may be provided between the second array of fibers and the third array of fibers. Additionally, the first dummy fiber may be configured to assist in maintaining the rotational orientation and/or the position of the first spacer with respect to at least the first array of fibers, and the first dummy fiber may be configured to assist in maintaining a rotational orientation and/or a position of the second spacer with respect to at least the third array of fibers. Additionally, in some embodiments, the second spacer may include the second portion.

In another example embodiment, a fiber array unit is provided for improved positioning of fibers. The fiber array unit includes a fiber array structure with a first portion and a second portion. The first portion has a first surface with a first set of grooves defined in the first surface, and each groove of the first set of grooves is configured to receive a fiber of a first array of fibers. The second portion has a second surface with a second set of grooves defined in the second surface, and each groove of the second set of grooves is configured to receive a fiber of a second array of fibers. The second set of grooves includes a first end groove, a second end groove, and one or more additional grooves between the first end groove and the second end groove. The first portion of the fiber array structure is configured to be placed adjacent to the second portion of the fiber array structure so that the first surface of the first portion faces the second surface of the second portion and so that the first set of grooves extend parallel to the second set of grooves. Further, the fiber array unit is configured to receive a spacer between the first array of fibers and the second array of fibers. The first end groove and/or the second end groove are configured to receive a first dummy fiber, and the first dummy fiber assists in maintaining a rotational orientation and/or a position of the spacer with respect to at least the first array of fibers.

In another example embodiment, a method is provided for making a system for improving positioning of fibers. The method includes providing the fiber array structure, with the fiber array structure having a first portion and a second portion. The first portion has a first surface with a first set of grooves defined in the first surface. Further, the second portion has a second surface with a second set of grooves defined in the second surface, and the second set of grooves includes a first end groove, a second end groove, and one or more additional grooves between the first end groove and the second end groove. The method also includes providing a first array of fibers, a second array of fibers, a spacer, and a first dummy fiber. Additionally, the method includes positioning each fiber of the first array of fibers within a groove of the first set of grooves, positioning each fiber of the second array of fibers within a groove of the second set of grooves, and positioning the spacer between the first array of fibers and the second array of fibers. Furthermore, the method includes positioning the first dummy fiber in one of the first end groove or the second end groove, with the first dummy fiber assisting in maintaining a rotational orientation and/or a position of the spacer with respect to at least the first array of fibers. The method also includes positioning the first portion of the fiber array structure adjacent to the second portion of the fiber array structure so that the first surface of the first portion faces the second surface of the second portion and so that the first set of grooves extend parallel to the second set of grooves.

In another example embodiment, a system for improved positioning of fibers is provided. The system includes a fiber array structure comprising a first portion and a second portion. The first portion has a first surface with a first set of grooves defined in the first surface, and the second portion has a second surface with a second set of grooves defined in the second surface. The system also includes a first array of fibers and a second array of fibers. Each fiber of the first array of fibers is positioned within a groove of the first set of grooves, and each fiber of the second array of fibers is positioned within a groove of the second set of grooves. The system also includes a spacer and a contact feature. The first portion of the fiber array structure is configured to be placed adjacent to the second portion of the fiber array structure so that the first surface of the first portion faces the second surface of the second portion and so that the first set of grooves extend parallel to the second set of grooves. The spacer is provided between the first array of fibers and the second array of fibers. The contact feature is provided at the second surface of the second portion adjacent to the second set of grooves, and the contact feature is configured to assist in maintaining a rotational orientation and/or a position of the spacer with respect to at least the second array of fibers.

In some embodiments, the contact feature may be configured to contact the spacer when the system is assembled. In some embodiments, the spacer may be configured to contact each of the fibers in the first array of fibers and the second array of fibers when the first array of fibers is received in the first set of grooves and when the second array of fibers is received in the second set of grooves.

In some embodiments, the contact feature may be integral to the second portion of the fiber array structure, and the contact feature may protrude from the second surface of the second portion of the fiber array structure when the contact feature is integral to the second portion. In some embodiments, the contact feature may be an object that is not integral to the second portion of the fiber array structure. Furthermore, the second set of grooves may include a first end groove, a second end groove, and one or more additional grooves between the first end groove and the second end groove. The contact feature may be received in the first end groove or the second end groove and protrudes past the second surface of the second portion of the fiber array structure.

In some embodiments, the contact feature may be configured to assist in maintaining a rotational orientation and/or a position of at least one fiber in the first array of fibers or the second array of fibers. In some embodiments, the contact feature may be configured to contact the spacer to assist in maintaining the rotational orientation and/or the position of the spacer. Contact between the contact feature and the spacer may cause the spacer to contact a fiber in the first array of fibers or the second array of fibers so that the fiber may be maintained in a proper rotational orientation and/or a proper position within a groove of the first set of grooves or the second set of grooves. Additionally, in some embodiments, the contact feature may be configured to assist in controlling the orientation of a fiber in the first array of fibers or the second array of fibers.

In another example embodiment, a fiber array unit is provided for improved positioning of fibers. The fiber array unit has a fiber array structure including a first portion and a second portion. The first portion has a first surface with a first set of grooves defined in the first surface, and each groove of the first set of grooves is configured to receive a fiber of a first array of fibers. The second portion has a second surface with a second set of grooves defined in the second surface, and each groove of the second set of grooves is configured to receive a fiber of the second array of fibers. The fiber array unit also includes a spacer and a contact feature. The first portion of the fiber array structure is configured to be placed adjacent to the second portion of the fiber array structure so that the first surface of the first portion faces the second surface of the second portion and so that the first set of grooves extend parallel to the second set of grooves. The fiber array unit is configured to receive the spacer between the first array of fibers and the second array of fibers. The contact feature is provided at the second surface of the second portion adjacent to the second set of grooves, and the contact feature is configured to assist in maintaining a rotational orientation and/or a position of the spacer with respect to at least the second array of fibers.

### BRIEF DESCRIPTION OF THE DRAWINGS

Reference will now be made to the accompanying drawings, which are not necessarily drawn to scale, and wherein:

FIG. 1A is a perspective view illustrating an example two-dimensional fiber array structure, in accordance with some embodiments discussed herein;

FIG. 1B is an exploded view illustrating the example two-dimensional fiber array structure of FIG. 1A, in accordance with some embodiments discussed herein;

FIG. 2 is a cross-sectional view illustrating an example two-dimensional fiber array structure and fibers provided therein, in accordance with some embodiments discussed herein;

FIG. 3A is a side, cross-sectional view illustrating the example two-dimensional fiber array structure of FIG. 2, in accordance with some embodiments discussed herein;

FIG. 3B is an enhanced, cross-sectional view illustrating the example two-dimensional fiber array structure of FIG. 3A, in accordance with some embodiments discussed herein;

FIG. 4A is a cross-sectional view illustrating an example two-dimensional fiber array structure having dummy fibers therein, in accordance with some embodiments discussed herein;

FIG. 4B is an enhanced, cross-sectional view illustrating the example two-dimensional fiber array structure of FIG. 4A where a dummy fiber may be more easily seen, in accordance with some embodiments discussed herein;

FIG. 4C is a cross-sectional view illustrating an example two-dimensional fiber array structure having contact features, in accordance with some embodiments discussed herein;

FIG. 4D is an enhanced, cross-sectional view illustrating the example two-dimensional fiber array structure of FIG. 4C where contact features may be more easily seen, in accordance with some embodiments discussed herein;

FIG. 5 is a cross-sectional view illustrating an example fiber array structure for receiving two arrays of fibers, in accordance with some embodiments discussed herein;

FIG. 6 is a cross-sectional view illustrating an example fiber array structure for receiving three arrays of fibers, in accordance with some embodiments discussed herein;

FIG. 7 is a perspective view illustrating an example fiber, in accordance with some embodiments discussed herein; and

FIG. 8 is a flow chart illustrating an example method for manufacturing a fiber array structure or system, in accordance with some embodiments discussed herein.

### DETAILED DESCRIPTION

Example embodiments of the present disclosure now will be described more fully hereinafter with reference to the accompanying drawings, in which some, but not all embodiments are shown. Indeed, the invention may be embodied in many different forms and should not be construed as limited to the example embodiments set forth herein; rather, these embodiments are provided so that this disclosure will satisfy applicable legal requirements. Like reference numerals generally refer to like elements throughout. For example, reference numerals 124A, 324A, 424A, etc. are each intended to refer to a spacer. Additionally, any connections or attachments may be direct or indirect connections or attachments unless specifically noted otherwise. While the positioning of certain components are described below based on the orientations presented in the relevant figures, the positioning of these components may be altered where the orientation of the fiber array structure or other components are changed. For example, while a first portion may be illustrated and described as being provided below a second portion herein, it is intended that the fiber array structure may be provided in other orientations so that the first portion and the second portion have different positions relative to each other.

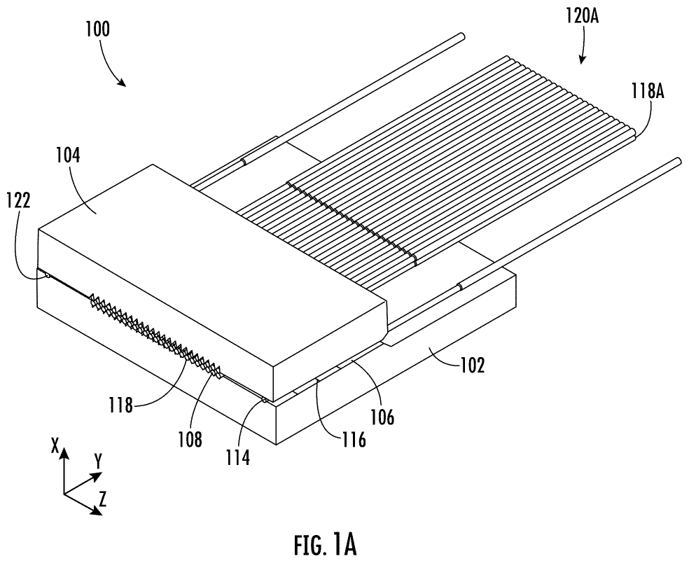

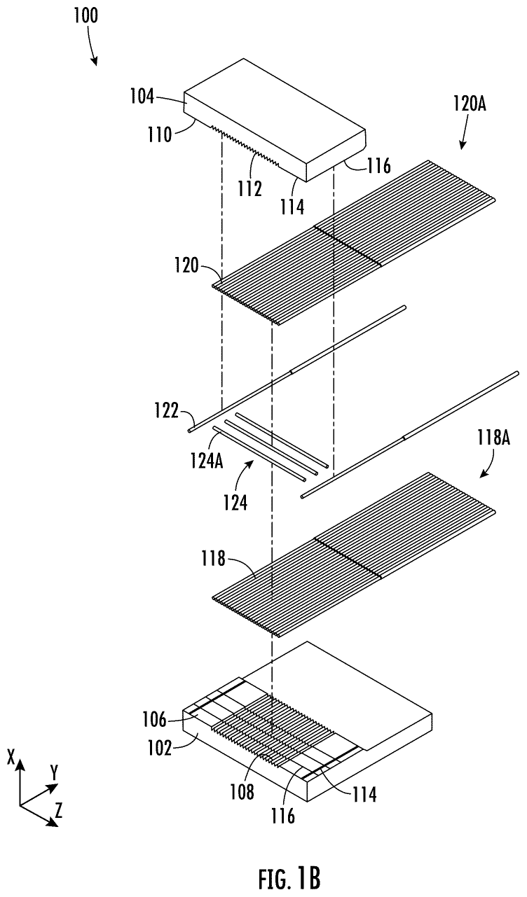

FIG. 1A is a perspective view illustrating an example two-dimensional fiber array structure 100, and FIG. 1B is an exploded view illustrating the example two-dimensional fiber array structure 100 of FIG. 1A where certain individual components may be more easily seen. The fiber array structure 100 includes a first portion 102 and a second portion 104 that may be provided adjacent to the first portion 102. In the illustrated embodiment, the second portion 104 is provided over the first portion 102, but the relative orientation of the two portions may be altered in other embodiments. The first portion 102 includes a first surface 106, and a first set of grooves 108 is defined in the first surface 106. Furthermore, the second portion 104 includes a second surface 110 (see FIG. 1B), and a second set of grooves 112 (see FIG. 1B) is defined in the second surface 110. Other than the grooves defined in the first surface 106 and the second surface 110, the two surfaces may generally possess a flat shape. Grooves may be formed through high precision machining. The shape and size of the first set of grooves 108 may impact the rotational orientation and/or the position of the first array of fibers 118 in the X-direction, the Y-direction, the Z-direction, and the shape and size of the first set of grooves 108 may indirectly impact the rotational orientation and/or the position of the spacers 124A. Similarly, the shape and size of the second set of grooves 112 may impact the rotational orientation and/or the position of the second array of fibers 120 in the X-direction, the Y-direction, the Z-direction, and the shape and size of the second set of grooves 112 may indirectly impact the rotational orientation and/or the position of the spacers 124A.

As illustrated in FIG. 1A, arrays of fibers are provided, and each of these fibers is partially received in a groove within the fiber array structure 100. For example, a first array of covered fibers 118A may be provided. The first array of covered fibers 118A provide fibers having fiber cores that are covered by one or more layers of coating. Some or all of this coating may be removed to expose the core of fibers within the first array of covered fibers 118A. The first array of fibers 118 may consist of the uncovered fiber cores. The first array of fibers 118 may be partially received in the first set of grooves 108 in the first surface 106 of the first portion 102 of the fiber array structure 100. Additionally, a second array of covered fibers 120A is provided. The second array of covered fibers 120A provides fibers that are covered by one or more layers of coating. Some or all of this coating may be removed to expose the core of fibers within the second array of covered fibers 120A. The second array of fibers 120 may consist of the uncovered fiber cores. The second array of fibers 120 may be partially received in the second set of grooves 112 in the second surface 110 of the first portion 102 of the fiber array structure 100. While the first array of fibers 118 and the second array of fibers 120 are illustrated as being covered by coating in some portions, in other embodiments, these arrays of fibers may be covered across their entire length, or these arrays of fibers may be provided without any coating at all.

Each of the first portion 102 and the second portion 104 include outer grooves 114. While the first set of grooves 108 and the second set of grooves 112 are generally grouped together, the outer grooves 114 may be provided away from these other sets of grooves. In the illustrated embodiment, the outer grooves 114 are provided proximate to the sides of the first portion 102 and the second portion 104. The outer grooves 114 are each configured to receive a portion of a positioning fiber 122. By doing so, one may ensure that the first portion 102 and the second portion 104 are positioned correctly relative to each other along the Z-axis. This may be beneficial to ensure that the first set of grooves 108 and the second set of grooves 112 are positioned appropriately relative to each other. In the illustrated embodiment of FIGS. 1A and 1B, the first set of grooves 108 and the second set of grooves 112 extend in a first direction that is parallel to the Y-axis. However, the orientation of the fiber array structure 100 may be altered in other embodiments. While the positioning fiber 122 is illustrated as being provided without coating in some portions and with coating in other portions, in other embodiments, the positioning fiber 122 may have coating across its entire length, or the positioning fiber 122 may be provided without any coating at all.

Additionally, each of the first portion 102 and the second portion 104 include transverse grooves 116. In the illustrated embodiment, the transverse grooves 116 extend in a second direction that is parallel to the Z-axis. In this way, the direction of the transverse grooves 116 is perpendicular to the direction of the first set of grooves 108 and the direction of the second set of grooves 112. A spacer layer 124 may be provided between the first surface 106 of the first portion 102 and the second surface 110 of the second portion 104. The spacer layer 124 may include one or more spacers 124A, and the spacers 124A may take the form of fibers, a sheet, or some other object. In the illustrated embodiment, the spacers 124A come in the form of fibers. The spacers 124A have a uniform cross-section in the X-Y plane along the Z-direction, but notches or deviations in the cross-section may be provided in some embodiments at certain locations along the Z-direction. The spacers 124A may be configured to rest between the first array of fibers 118 and the second array of fibers 120. The transverse grooves 116 are each be configured to receive a portion of a spacer 124A, and the transverse grooves 116 are configured to restrict movement of the first portion 102 and the second portion 104 relative to each other along the Y-axis. For example, in the illustrated embodiment of FIG. 1B, spacers 124A are provided in the form of fibers, and each transverse groove 116 is configured to receive a portion of a spacer 124A.

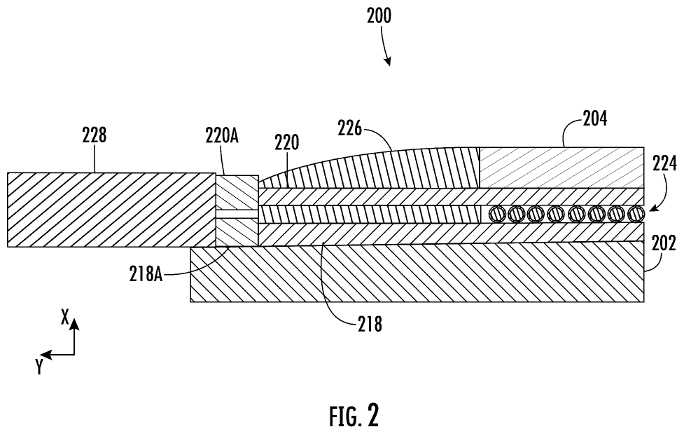

Further features of the fiber array structure are illustrated in the schematic, cross-sectional view of FIG. 2. As illustrated, a fiber array structure 200 is provided having a first portion 202 and a second portion 204. This cross-section extends in the X-Y plane relative to the fiber array structure 100 illustrated in FIGS. 1A-1B. Each fiber of the first array of fibers 218 may be partially received in a groove of the first set of grooves 108 (see FIG. 1B) of the first portion 202, and each fiber of the second array of fibers 220 may be partially received in a groove of the second set of grooves 112 (see FIG. 1B) of the second portion 204. The spacer layer 224 includes one or more spacers 124A (see FIG. 1B). The spacer layer 224 is provided between first portion 202 and the second portion 204 so that the spacer layer 224 is positioned between the first array of fibers 218 and the second array of fibers 220. The first array of fibers 218 may have covered portions so that a first array of covered fibers 218A is provided, and the second array of fibers 220 may also have covered portions so that a second array of covered fibers 220A is provided. The first array of covered fibers 218A and the second array of covered fibers 220A may each be received in a fiber ribbon 228 in some embodiments to further protect and organize the fibers of the arrays. Furthermore, once the relevant components are assembled, epoxy 226 may be added to at least partially restrict the movement of the fibers and the other components. The fibers in the first array of fibers 218 and the second array of fibers 220 may be optical fibers in some embodiments, but other types of fibers may be used. The optical fibers may be polarization maintaining optical fibers or multi-core fibers in some embodiments.

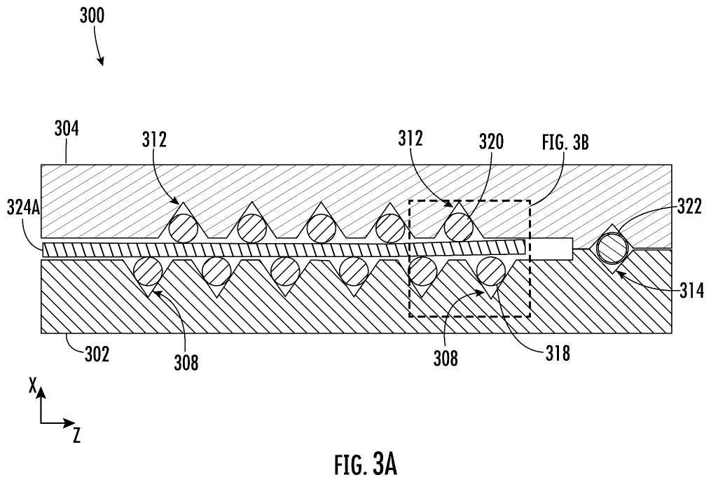

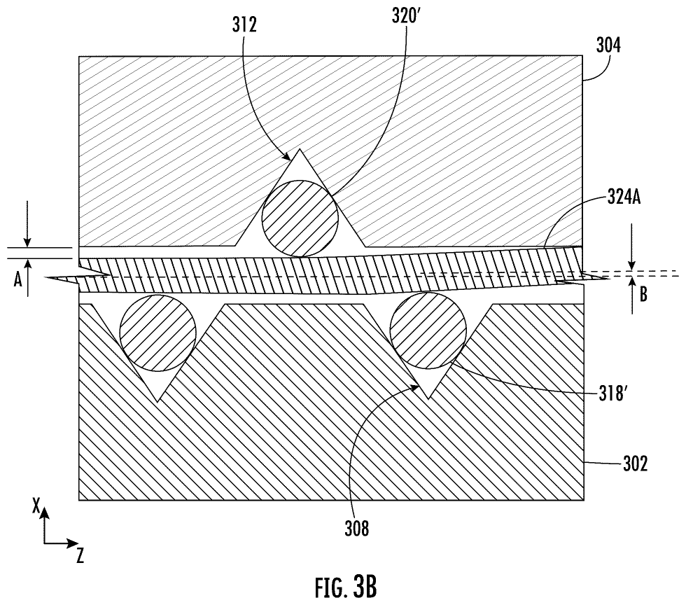

While FIG. 2 provides a cross-sectional view about the X-Y axis, FIG. 3A illustrates another cross-sectional view about the X-Z axis. As illustrated, the fiber array structure 300 includes a first portion 302 and a second portion 304, with the first portion 302 having a first set of grooves 308 and with the second portion 304 having a second set of grooves 312. Furthermore, each of the first portion 302 and the second portion 304 include an outer groove 314, with the outer groove 314 being configured to receive a positioning fiber 322 to assist in positioning the first portion 302 and the second portion 304 relative to each other in the Z-direction. As illustrated, the first set of grooves 308 and the second set of grooves 312 are offset from each other along the Z-direction, with each groove of the first set of grooves 308 generally positioned along the Z-direction between two grooves of the second set of grooves 312. Similarly each groove of the second set of grooves 312 is generally positioned along the Z-direction between two grooves of the first set of grooves 308.

A first array of fibers 318 and a second array of fibers 320 are provided as well. Each fiber of the first array of fibers 318 may be at least partially received within a groove of the first set of grooves 308, and each fiber of the second array of fibers 320 may be at least partially received within a groove of the second set of grooves 312. One or more spacers 324A may be provided between the first array of fibers 318 and the second array of fibers 320. The spacers 324A are configured to contact each fiber of the first array of fibers 318, and the spacers 324A are configured to contact each fiber of the second array of fibers 320. In this way, the spacers 324A may assist in controlling the rotational orientation of the fibers as well as the positioning (e.g. in the X-direction, Y-direction, Z-direction, etc.) of the fibers.

Controlling the position and rotational orientation of fibers and the spacers is an important consideration. If the position or rotational orientation of fibers is incorrect, then this may prevent the fibers from functioning appropriately. It is particularly important to appropriately maintain the rotational orientation of fibers for certain types of fibers like polarization maintaining optical fibers or multi-core fibers. Furthermore, if the position or rotational orientation of a spacer is incorrect, then this may indirectly impact the positioning or rotational orientation of other components such as the first array of fibers 318, the second array of fibers 320, the first portion 302, or the second portion 304.

As illustrated in FIG. 3A, the first set of grooves 312 and the second set of grooves 308 are offset from each other along the Z-direction, and this offset may often result in incorrect positioning of spacers 324A, fibers of the first array of fibers 318, or fibers of the second array of fibers 320. This issue is illustrated most clearly in the enhanced view of FIG. 3B. As illustrated in FIG. 3A and 3B, the spacer 324A generally extends along the Z-direction at the left hand side of the spacer 324A in the figures. However, as the spacer 324A extends to the right and past the last fiber 320′ of the second array of fibers 320, the spacer 324A begins extending at a different direction with a vertical element along the X-direction (this may occur during manufacturing and/or over time). As illustrated in FIG. 3B, the position in the X-direction of the spacer 324A at the last fiber 318′ of the first array of fibers 318 is offset from the position in the X-direction of the spacer 324 at the last fiber 320′ of the second array of fibers 320 by a distance (B). This distance (B) may take a wide variety of values. For example, the distance (B) may range from zero to ten (10) micrometers, from zero to eight (8) micrometers, from zero to five (5) micrometers, or from one (1) micrometer to three (3) micrometers in some embodiments. Because there is no additional fiber or object past the last fiber 320′ of the second array of fibers 320 illustrated in FIG. 3B, the spacer 324A may shift along the X-axis and may be distorted in size or shape. As an indirect consequence of this distortion, the last fiber 318′ on the far right of the first array of fibers 318 may be permitted to rotate more freely within the groove and may also be permitted to shift in position within the groove. These unwanted changes in the positioning of the last fiber 318′ may result in the last fiber 318′ being less effective, and it is therefore desirable to have solutions that better control the rotational orientation and position of fibers and spacers. While this example is illustrated with distortion in the rotational orientation and position of the spacer 324A only at the right side of the spacer 324A, distortion may occur on the left side of the spacer 324A in FIG. 3B.

FIG. 3B also illustrates a gap between the spacer 324A and the second portion 304, with the spacer 324A and the second portion 304 separated by a distance (A). The distance (A) may be varied in some embodiments, and the distance (A) may depend on the cross-sectional size of fibers (or the diameter of fibers where the fibers have a circular cross-section), the shape of the grooves, and the cross-sectional size of spacers (or the diameter of spacers where the spacers have a circular cross-section). In some embodiments, it may be beneficial to provide the components so that the distance (A) is a non-zero value. This may be beneficial to account for imperfections within the shape of the first portion 302 or the second portion 304. The distance (A) is thirty (30) micrometers in the illustrated embodiment, but the distance (A) may possess other values. The gap between the spacer 324A and the first portion 302 may be defined by the distance (A).

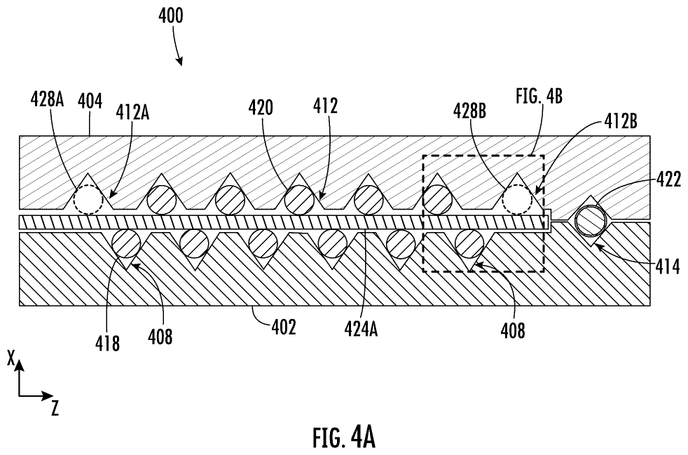

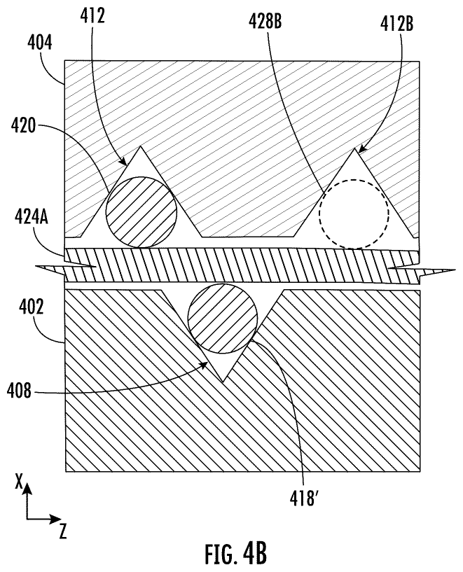

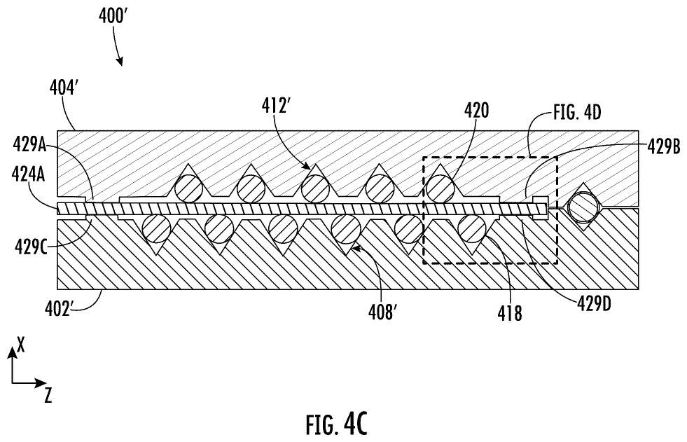

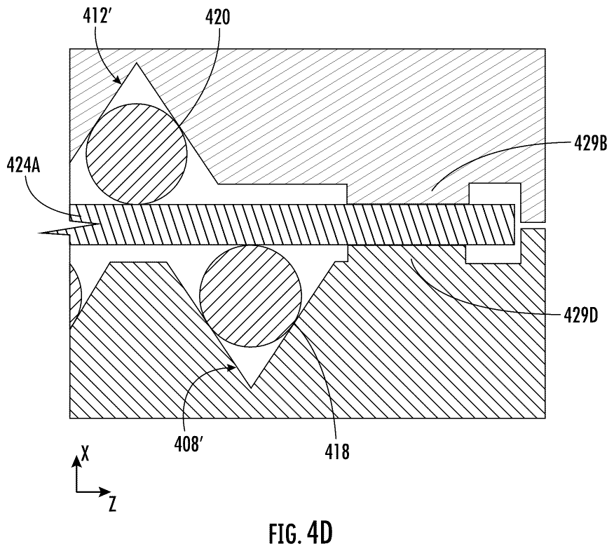

The embodiments illustrated in FIGS. 4A and 4B are similar to the embodiments illustrated in FIGS. 3A and 3B, but contact features, such as dummy fibers, are introduced to better control the rotational orientation and position of spacers and fibers. The contact features may assist in providing more uniform forces acting on the spacer in certain critical portions so that fibers are positioned and oriented appropriately. Notably, while some embodiments illustrate dummy fibers being used as contact features, other objects are contemplated (e.g., rods, balls, objects of other shapes, protrusions or other surface features). Notably, such contact feature(s) engage the spacer at an appropriate position (e.g., after the last fiber in a set of fibers) to maintain the desired relative orientation and/or position of the spacer with respect to the fibers.

FIG. 4A is a cross-sectional view illustrating an example two-dimensional fiber array structure having dummy fibers therein. FIG. 4B is an enhanced, cross-sectional view illustrating the example two-dimensional fiber array structure of FIG. 4A where a dummy fiber may be more easily seen. Similar to the embodiments of FIGS. 3A and 3B, the fiber array structure 400 possesses a first portion 402 and a second portion 404, with a first set of grooves 408 in the first portion 402 and a second set of grooves 412 in the second portion 404. Each fiber of the first array of fibers 418 are partially received in a respective groove of the first set of grooves 408, and each fiber of the second array of fibers 420 are partially received in a respective groove of the second set of grooves 412. Outer grooves 414 are provided in each of the first portion 402 and the second portion 404, and the outer grooves 414 are configured to receive the positioning fiber 422 so that the first portion 402 and the second portion 404 may be positioned appropriately relative to each other. Also spacers 424A are provided between the first array of fibers 418 and the second array of fibers 420.

Relative to the examples illustrated in FIGS. 3A and 3B, improvements have been made in the embodiments of FIGS. 4A and 4B to assist in controlling the rotational orientation and position of fibers and spacers. In the illustrated embodiment, a first end groove 412A and a second end groove 412B are added in the second set of grooves 412. The first end groove 412A of the second set of grooves 412 is provided beyond each of the other grooves of the first set of grooves 408 in the negative Z-direction. Furthermore, the second end groove 412B of the second set of grooves 412 is provided beyond each of the other grooves of the first set of grooves 408 in the positive Z-direction.

The first end groove 412A is configured to partially receive a first dummy fiber 428A and the second end groove 412B is configured to partially receive a second dummy fiber 428B. The first dummy fiber 428A and the second dummy fiber 428B are configured to protrude outwardly from their respective grooves to come in contact with one or more spacers 424A. By doing so, the first dummy fiber 428A and the second dummy fiber 428B may assist in maintaining the appropriate rotational orientation and position of the spacer 424A. Furthermore, contact between a respective dummy fiber and the spacer 424A maintains fibers of the first array of fibers 418 in their appropriate rotational orientation and position in their respective grooves. For example, looking at FIG. 4B, the second dummy fiber 428B contacts the spacer 424A to urge the spacer 424A downwardly, and this causes the spacer 424A to contact the last fiber 418′ of the first array of fibers 418 (see FIG. 4A). This contact with the last fiber 418′ of the first array of fibers 418 (see FIG. 4A) ensures that the last fiber 418′ retains the appropriate rotational orientation and position. While a distance (B) is illustrated in FIG. 3B as the offset in the position of the spacer in the X-direction, the use of dummy fibers minimizes this distance (B) and may make this distance (B) approximately zero. While the first end groove 412A and the second end groove 412B are illustrated as being part of the second set of grooves 412, the first end groove 412A and the second end groove 412B may be provided in the first set of grooves 408 in other embodiments.

FIGS. 4C-4D illustrate a fiber array structure using contact features configured to maintain positioning and/or orientation of the spacer(s). FIG. 4C illustrates a cross-sectional view of an example two-dimensional fiber array structure 400′ having such contact features, and FIG. 4D is an enhanced, cross-sectional view allowing the contact features of FIG. 4C to be more easily seen.

Similar to the embodiments of FIGS. 4A and 4B, the fiber array structure 400′ possesses a first portion 402′ and a second portion 404′, with a first set of grooves 408′ in the first portion 402′ and a second set of grooves 412′ in the second portion 404′. Each fiber of the first array of fibers 418 are partially received in a respective groove of the first set of grooves 408′, and each fiber of the second array of fibers 420 are partially received in a respective groove of the second set of grooves 412′. Also spacers 424A are provided between the first array of fibers 418 and the second array of fibers 420.

In the fiber array structure 400′ of FIGS. 4C and 4D, the first portion 402′ has a first contact feature 429A and a second contact feature 429B, with both the first contact feature 429A and the second contact feature 429B being integral to the first portion 402′. The first contact feature 429A and the second contact feature 429B are both configured to protrude from the first portion 402′ to contact the spacer 424A. Additionally, the second portion 404′ has a third contact feature 429C and a fourth contact feature 429D, with both the third contact feature 429C and the fourth contact feature 429D being integral to the second portion 404′. The third contact feature 429C and the fourth contact feature 429D are both configured to protrude from the second portion 404′ to contact the spacer 424A. The first contact feature 429A and the third contact feature 429C may contact the spacer 424A at a first end of the spacer 424A on the left, and these contact features aid in restricting rotational movement of the spacer 424A and/or movement along the X-direction, the Y-direction, and/or the Z-direction. Similarly, the second contact feature 429B and the fourth contact feature 429D may contact the spacer 424A on a second end of the spacer on the right, and these contact features may aid in restricting rotational movement of the spacer 424A and/or movement along the X-direction, the Y-direction, and/or the Z-direction. The contact features may protrude outwardly with a shape that generally conforms to the shape of a rectangular prism in some embodiments, but the shape of the contact feature may be different in other embodiments. For example, the contact feature may possess a curvature or may possess a geometry that partially envelops the spacer along the Y-direction.

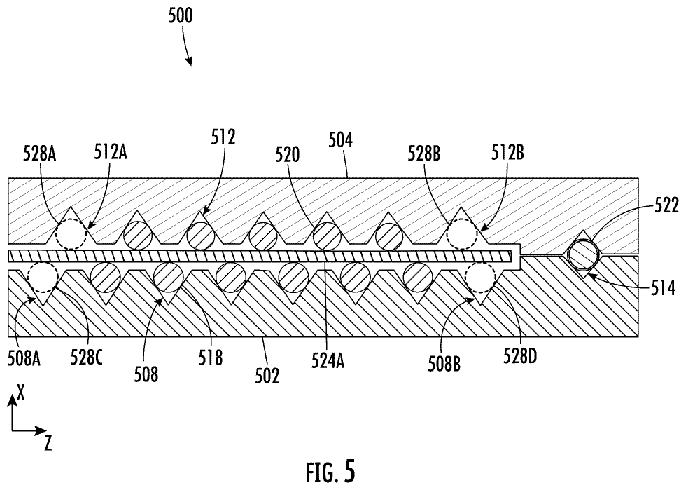

Dummy fibers may be provided at other locations in some embodiments to further ensure that the appropriate rotational orientation and position of the spacers and other fibers are maintained. FIG. 5 illustrates an additional example of dummy fibers being used. FIG. 5 is a cross-sectional view illustrating an example fiber array structure for receiving two arrays of fibers.

The embodiments illustrated in FIG. 5 are similar to the embodiments illustrated in FIGS. 4A and 4B in several respects. FIG. 5 is a cross-sectional view illustrating an example two-dimensional fiber array structure 500 having dummy fibers therein. Similar to the embodiments of FIGS. 4A and 4B, a first portion 502 and a second portion 504 are provided, with a first set of grooves 508 in the first portion 502 and a second set of grooves 512 in the second portion 504. Each fiber of the first array of fibers 518 is partially received in a respective groove of the first set of grooves 508, and each fiber of the second array of fibers 520 is partially received in a respective groove of the second set of grooves 512. Outer grooves 514 are provided in each of the first portion 502 and the second portion 504, and the outer grooves 514 are configured to receive the positioning fiber 522 so that the first portion 502 and the second portion 504 are positioned appropriately relative to each other. Also spacers 524A are provided between the first array of fibers 518 and the second array of fibers 520.

Additionally, in FIG. 5, the first set of grooves 508 include a first end groove 508A and a second end groove 508B, and additional grooves of the first set of grooves 508 are provided between the first end groove 508A and the second end groove 508B. The second set of grooves 512 include a first end groove 512A and a second end groove 512B, and additional grooves of the second set of grooves 512 are provided between the first end groove 512A and the second end groove 512B.

Dummy fibers are partially received within some or all of the end grooves. For example, in the illustrated embodiment of FIG. 5, the first end groove 512A of the second set of grooves 512 receives a portion of a first dummy fiber 528A, the second end groove 512B of the second set of grooves 512 receives a portion of a second dummy fiber 528B, the first end groove 508A of the first set of grooves 508 receives a portion of a third dummy fiber 528C therein, and the second end groove 508B of the first set of grooves 508 receives a portion of a fourth dummy fiber 528D therein. By providing dummy fibers, one may better ensure that the spacer 524A and the additional fibers extending between the end fibers are provided with an appropriate rotational orientation and position.

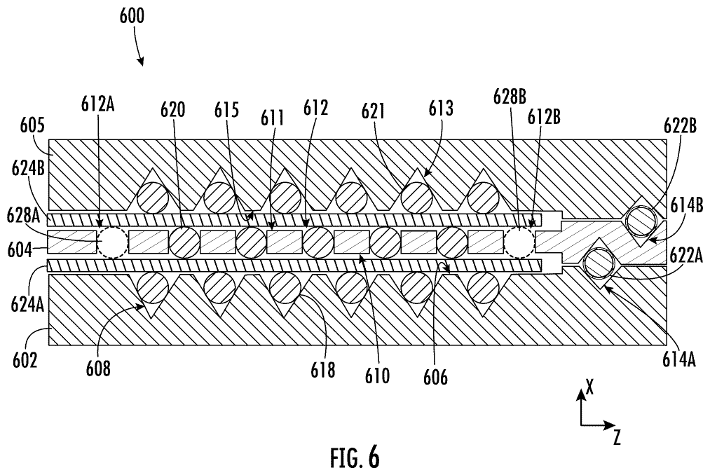

In some embodiments, fiber array structures may be provided that are configured to receive and control the positioning of the three or more arrays of fibers. FIG. 6 is a cross-sectional view illustrating an example fiber array structure 600 for receiving three arrays of fibers. The fiber array structure 600 includes a first portion 602, a second portion 604, and a third portion 605. A first set of grooves 608 are defined in a first surface 606 of the first portion 602, and each groove of the first set of grooves 608 are configured to receive a portion of a fiber of the first array of fibers 618. A second set of grooves 612 are defined in a second surface 610 of the second portion 604, and the second set of grooves 612 extend from the second surface 610 to the opposing surface 611 of the second portion 604. Each grooves of the second set of grooves 612 are configured to receive a portion of a fiber of the second array of fibers 620. Furthermore, a third set of grooves 613 are defined in a third surface 615 of the third portion 605, and each grooves of the third set of grooves 613 is configured to receive a portion of a fiber of the third array of fibers 621. One or more first spacers 624A are provided between the first portion 602 and the second portion 604 so that the first spacers 624A rest between the first array of fibers 618 and the second array of fibers 620. Additionally, one or more second spacers 624B are provided between the second portion 604 and the third portion 605 so that the second spacers 624B rest between the second array of fibers 620 and the third array of fibers 621.

Additionally, the first portion 602 and the second portion 604 each possess outer grooves 614A that are configured to receive a portion of a first positioning fiber 622A, and this first positioning fiber 622A assists in maintaining the appropriate positioning of the first portion 602 and the second portion 604 relative to each other along the Z-direction. Furthermore, the second portion 604 and the third portion 605 each possess outer grooves 614B that are configured to partially receive a second positioning fiber 622B, and this second positioning fiber 622B assists in maintaining the appropriate positioning of the second portion 604 and the third portion 605 relative to each other along the Z-direction. When appropriately positioned, the second portion 604 of the fiber array structure are provided adjacent to the third portion 605 of the fiber array structure so that the opposing surface 611 of the second portion 604 faces the third surface 615 of the third portion 605 and so that the second set of grooves 612 extends parallel to the third set of grooves 613.

In the illustrated embodiment of FIG. 6, the second set of grooves 612 are provided with a first end groove 612A and a second end groove 612B. The first end groove 612A of the second set of grooves 612 is provided beyond each of the other grooves of the first set of grooves 608 and the third set of grooves 613 in the negative Z-direction. Furthermore, the second end groove 612B of the second set of grooves 612 is provided beyond each of the other grooves of the first set of grooves 608 and the third set of grooves 613 in the positive Z-direction.

The first dummy fiber 628A is partially received in the first end groove 612A of the second set of grooves 612, and the second dummy fiber 628B is partially received in the second end groove 612B of the second set of grooves 612. The first dummy fiber 628A and the second dummy fiber 628B are both configured to assist in maintaining a rotational orientation and/or a position of the first spacer 624A with respect to at least the first array of fibers 618, and the first dummy fiber 628A and the second dummy fiber 628B are both configured to assist in maintaining a rotational orientation and/or a position of the second spacer 624B with respect to at least the third array of fibers 621.

In some embodiments, the second portion 604 may be integral to one of the spacers 624A, 624B. In some embodiments, one or more parts of the second portion 604 (such as the second set of grooves 612) may extend from one of the spacers. In such an example embodiment, there may only be need for one positioning fiber and the first portion 602 may abut the third portion 605, with the three arrays of fibers in respective grooves and the spacers (one with the second set of grooves) positioned therebetween.

In some embodiments, dummy fibers may generally possess an identical size and shape compared to the other fibers of the first array of fibers and the second array of fibers. Furthermore, the dummy fibers may comprise certain materials that are also provided in the first array of fibers and/or the second array of fibers. However, in other embodiments, the dummy fibers may possess a different size, a different shape, or one or more different materials than the other fibers of the first array of fibers and the second array of fibers. For example, in some embodiments, the dummy fibers may possess a larger cross-sectional area (or a larger diameter where a circular cross-section is used) than the fibers of the first array of fibers and the second array of fibers. In some embodiments, the dummy fibers may comprise material that is more easily deformable than the material of the fibers in the first array of fibers and the second array of fibers, and increased deformability in the material of the dummy fibers may permit a larger surface area of the dummy fibers to be in contact with spacers so that the amount of friction between the dummy fibers and the spacer is increased. However, the dummy fibers may comprise material that is less deformable (e.g., more rigid) than the material of other fibers in other embodiments, which may aid in limiting positional or rotational shifting of the spacer(s).

In some embodiments, one or more contact features may be provided in or alongside the fiber array structure to assist in controlling the rotational orientation and/or the position of a spacer. A contact feature may take the form of a dummy fiber as described above, but a contact feature may be provided in another form. For example, the contact feature may be some object other than a fiber that is provided alongside the fiber array structure, and this object may extend out of a respective end groove and the surface that the respective end groove is provided in to contact a spacer. Alternatively, rather than providing the object in an end groove, the object may be attached (e.g. via fasteners, adhesives, etc.) to a surface of the first portion 302 (see FIG. 3A), the second portion 304 (see FIG. 3A), etc. so that the object assists in maintaining contact with the spacer.

As a further alternative, the contact feature may be provided integral to one of the first portion 302 (see FIG. 3A), the second portion 304 (see FIG. 3A), etc., and the contact feature may extend outwardly from a respective surface to come in contact with a spacer to assist in controlling the rotational orientation and/or the position of the spacer (see e.g., FIGS. 4C and 4D). For example, the contact feature may be integral to one of the first portion of the fiber array structure or the second portion of the fiber array structure. In some embodiments, the fiber array structure may be configured so that the first surface of the first portion or the second surface of the second portion comes in contact with the spacer, and the first surface or the second surface may be considered to be the contact feature.

Additionally, where some fibers in a fiber array are more sensitive to error than other fibers, the sensitive fibers may be provided in more central grooves of a set of grooves, and less sensitive fibers may be provided in grooves closer to the end grooves. For example, where only a portion of the fibers in an array of fibers are polarization maintaining fibers or multi-core fiber, these polarization maintaining fibers or multi-core fibers may be provided in more central grooves while less sensitive fibers may be provided in grooves closer to the end grooves. Because it is often critical to maintain the proper rotational orientation of polarization maintaining fibers and multi-core fibers, placement of these fibers at central locations may reduce the likelihood of improper rotational orientations for these fibers. Where less sensitive fibers are provided in end grooves, these less sensitive fibers may constitute contact features.

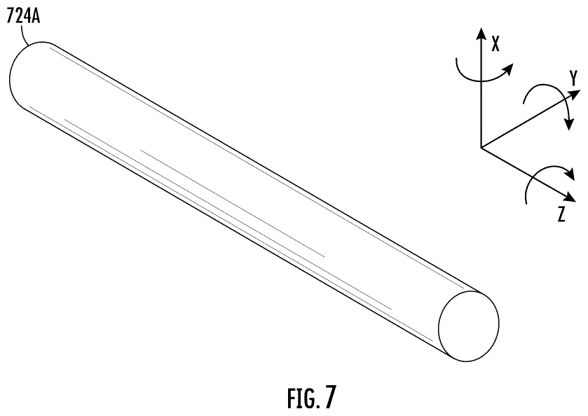

With reference to FIG. 7, and to expand upon some concepts detailed herein, if left uncontrolled, a spacer may shift to improper positions. For example, the spacer 724A may generally extend in a lengthwise direction that is parallel to the Y-axis in FIG. 7. Ideally, the spacer 724A maintains this orientation and position in use, but certain forces acting on the spacer 724A may cause this orientation and position to be altered. For example, where other fibers or contact features are in contact with the spacer 724A above and below the spacer 724A, this may cause the spacer 724A to shift upwardly or downwardly at an end of the spacer 724A and rotation may be induced about the Z-axis at the ends. Furthermore, improper positioning may occur in the spacer 724A as a result of improper positioning of fibers in grooves, as a result of imperfections in manufacturing, and as a result of deviations in sizing as a result of manufacturing tolerances. This improper positioning may result in unwanted changes in the positioning of the spacer 724A about the X-direction, the Y-direction, or the Z-direction, and the improper positioning may result in unwanted changes in the rotational orientation of the spacer 724A about the X-axis, the Y-axis, or the Z-axis.

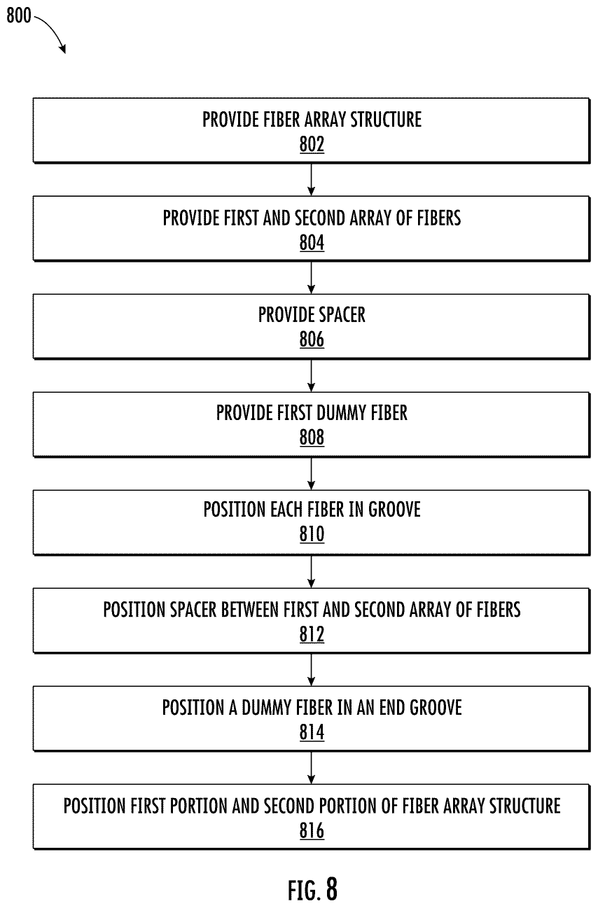

While various embodiments are described above of systems or fiber array structures, example methods of making such systems or fiber array structures is illustrated in FIG. 8. Various components may be provided. For example, at operation 802, a fiber array structure is provided. The fiber array structure may include a first portion and a second portion. The first portion may have a first surface with a first set of grooves defined in the first surface, and the second portion may have a second surface with a second set of grooves defined in the second surface. The second set of grooves may include a first end groove, a second end groove, and one or more additional grooves between the first end groove and the second end groove. At operation 804, a first array of fibers and a second array of fibers are provided. At operation 806, a spacer is provided. Furthermore, at operation 808, a first dummy fiber is provided. Alternatively, in some embodiments, a contact feature other than a dummy fiber may be provided, and the contact feature may be used in place of the dummy fiber.

At operation 810, each fiber of the first array of fibers and the second array of fibers are positioned in a groove. Each fiber of the first array of fibers may be received in a groove of the first set of grooves. Furthermore, each fiber of the second array of fibers may be received in a groove of the second set of grooves.

At operation 812, a spacer is positioned between the first array of fibers and the second array of fibers. At operation 814, a dummy fiber is positioned in an end groove. The dummy fiber may be positioned in the first end groove or the second end groove of the second set of grooves. The dummy fiber may assist in maintaining a rotational orientation or position of the spacer with respect to at least the first array of fibers.

At operation 816, the first portion and the second portion of the fiber array structure are positioned relative to each other. The first portion of the fiber array structure may be positioned adjacent to the second portion of the fiber array structure so that the first surface of the first portion faces the second surface of the second portion and so that the first set of grooves extend parallel to the second set of grooves.

While various operations are illustrated in FIG. 8 and described herein in a certain order, the order of operations may be altered in other embodiments. For example, operation 804 may be performed before operation 802, operation 814 may be performed before operation 812, etc. Alternatively, operation 802 and operation 804 may be performed simultaneously. Additionally, while various operations are illustrated in FIG. 8 and described herein, certain operations may be omitted in some embodiments, and additional operations may be performed in some embodiments.

### Conclusion

Many modifications and other embodiments set forth herein will come to mind to one skilled in the art having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A system for improved positioning of fibers, the system comprising:
a fiber array structure comprising:
a first portion having a first surface with a first set of grooves defined in the first surface; and
a second portion having a second surface with a second set of grooves defined in the second surface, wherein the second set of grooves includes a first end groove, a second end groove, and one or more additional grooves between the first end groove and the second end groove;
a first array of fibers, wherein each fiber of the first array of fibers is positioned within a groove of the first set of grooves;
a second array of fibers, wherein each fiber of the second array of fibers is positioned within a groove of the second set of grooves;
a first spacer; and
a first dummy fiber,
wherein the first portion of the fiber array structure is configured to be placed adjacent to the second portion of the fiber array structure so that the first surface of the first portion faces the second surface of the second portion and so that the first set of grooves extend parallel to the second set of grooves, wherein the first spacer is provided between the first array of fibers and the second array of fibers, wherein the first dummy fiber is provided in one of the first end groove or the second end groove, and wherein the first dummy fiber is configured to assist in maintaining at least one of a rotational orientation or a position of the first spacer with respect to at least the first array of fibers.

2. The system of claim 1, wherein the first dummy fiber is configured to contact the first spacer when the system is assembled.

3. The system of claim 1, wherein the first spacer is configured to contact each of the fibers in the first array of fibers and the second array of fibers when the first array of fibers is received in the first set of grooves and when the second array of fibers is received in the second set of grooves.

4. The system of claim 1, wherein the first dummy fiber is configured to assist in maintaining at least one of a rotational orientation or a position of at least one fiber in the first array of fibers or the second array of fibers.

5. The system of claim 1, wherein the first dummy fiber is configured to contact the first spacer to assist in maintaining the at least one of the rotational orientation or the position of the first spacer, and wherein contact between the first dummy fiber and the first spacer causes the first spacer to contact a fiber in the first array of fibers or the second array of fibers so that the fiber is maintained in at least one of a proper rotational orientation or a proper position within a groove of the first set of grooves or the second set of grooves.

6. The system of claim 5, wherein the first dummy fiber is configured to assist in controlling the orientation of a fiber in the first array of fibers or the second array of fibers.

7. The system of claim 6, wherein a fiber within the first array of fibers or the second array of fibers is a polarization maintaining optical fiber or a multi-core fiber.

8. The system of claim 1, further comprising:
a second dummy fiber,
wherein the first dummy fiber is provided in the first end groove, and wherein the second dummy fiber is provided in the second end groove.

9. The system of claim 1, wherein the first array of fibers and the second array of fibers extend in a first direction, wherein the first spacer extends in a second direction, and wherein the second direction is perpendicular to the first direction.

10. The system of claim 1, wherein each groove within the first set of grooves and the second set of grooves extends in a lengthwise direction, wherein the first set of grooves are aligned in a transverse direction that is perpendicular to the lengthwise direction, wherein the second set of grooves are aligned in the transverse direction, and wherein the first portion and the second portion are positioned relative to each other so that the first set of grooves and the second set of grooves are offset from each other in the transverse direction.

11. The system of claim 1, further comprising one or more additional spacers, wherein the first spacer and the one or more additional spacers are provided between the first array of fibers and the second array of fibers, and wherein the first dummy fiber is configured to assist in controlling the at least one of the rotational orientation or the position of the first spacer and the one or more additional spacers.

12. The system of claim 1, wherein a fiber of the first array of fibers or the second array of fibers is an optical fiber.

13. The system of claim 1, wherein the second portion has an opposing surface opposite of the second surface, wherein the fiber array structure further comprises:
a third portion having a third surface with a third set of grooves defined in the third surface;
a third array of fibers, wherein each fiber of the third array of fibers is positioned within a groove of the third set of grooves; and
a second spacer,
wherein the second portion of the fiber array structure is configured to be positioned between the first portion and the third portion of the fiber array structure, wherein the second portion of the fiber array structure is configured to be placed adjacent to the third portion of the fiber array structure so that the opposing surface of the second portion faces the third surface of the third portion and so that the second set of grooves extend parallel to the third set of grooves, wherein the second spacer is provided between the second array of fibers and the third array of fibers, wherein the first dummy fiber is configured to assist in maintaining the at least one of the rotational orientation or the position of the first spacer with respect to at least the first array of fibers, and wherein the first dummy fiber is configured to assist in maintaining at least one of a rotational orientation or a position of the second spacer with respect to at least the third array of fibers.

14. The system of claim 13, wherein the second spacer includes the second portion.

15. A fiber array unit for improved positioning of fibers, the fiber array unit comprising:
a fiber array structure comprising:
a first portion having a first surface with a first set of grooves defined in the first surface, wherein each groove of the first set of grooves is configured to receive a fiber of a first array of fibers; and
a second portion having a second surface with a second set of grooves defined in the second surface, wherein each groove of the second set of grooves is configured to receive a fiber of a second array of fibers, wherein the second set of grooves includes a first end groove, a second end groove, and one or more additional grooves between the first end groove and the second end groove,
wherein the first portion of the fiber array structure is configured to be placed adjacent to the second portion of the fiber array structure so that the first surface of the first portion faces the second surface of the second portion and so that the first set of grooves extend parallel to the second set of grooves, wherein the fiber array unit is configured to receive a spacer between the first array of fibers and the second array of fibers, wherein at least one of the first end groove or the second end groove are configured to receive a first dummy fiber, and wherein the first dummy fiber assists in maintaining at least one of a rotational orientation or a position of the spacer with respect to at least the first array of fibers.

16. A method for making a system for improving positioning of fibers, the method comprising:
providing the fiber array structure having a first portion and a second portion, wherein the first portion has a first surface with a first set of grooves defined in the first surface, wherein the second portion has a second surface with a second set of grooves defined in the second surface, wherein the second set of grooves includes a first end groove, a second end groove, and one or more additional grooves between the first end groove and the second end groove;
providing a first array of fibers;
providing a second array of fibers;
providing a spacer;
providing a first dummy fiber;
positioning each fiber of the first array of fibers within a groove of the first set of grooves;
positioning each fiber of the second array of fibers within a groove of the second set of grooves;
positioning the spacer between the first array of fibers and the second array of fibers;
positioning the first dummy fiber in one of the first end groove or the second end groove, wherein the first dummy fiber assists in maintaining at least one of a rotational orientation or a position of the spacer with respect to at least the first array of fibers; and
positioning the first portion of the fiber array structure adjacent to the second portion of the fiber array structure so that the first surface of the first portion faces the second surface of the second portion and so that the first set of grooves extend parallel to the second set of grooves.

17. A system for improved positioning of fibers, the system comprising:
a fiber array structure comprising:
a first portion having a first surface with a first set of grooves defined in the first surface; and
a second portion having a second surface with a second set of grooves defined in the second surface;
a first array of fibers, wherein each fiber of the first array of fibers is positioned within a groove of the first set of grooves;
a second array of fibers, wherein each fiber of the second array of fibers is positioned within a groove of the second set of grooves;
a spacer; and
a contact feature,
wherein the first portion of the fiber array structure is configured to be placed adjacent to the second portion of the fiber array structure so that the first surface of the first portion faces the second surface of the second portion and so that the first set of grooves extend parallel to the second set of grooves, wherein the spacer is provided between the first array of fibers and the second array of fibers, wherein the contact feature is provided at the second surface of the second portion adjacent to the second set of grooves, and wherein the contact feature is configured to assist in maintaining at least one of a rotational orientation or a position of the spacer with respect to at least the second array of fibers.

18. The system of claim 17, wherein the contact feature is configured to contact the spacer when the system is assembled.

19. The system of claim 17, wherein the spacer is configured to contact each of the fibers in the first array of fibers and the second array of fibers when the first array of fibers is received in the first set of grooves and when the second array of fibers is received in the second set of grooves.

20. The system of claim 17, wherein the contact feature is integral to the second portion of the fiber array structure, wherein the contact feature protrudes from the second surface of the second portion of the fiber array structure when the contact feature is integral to the second portion.
